(19) United States
(12) Patent Application Publication
(10) Pub. No.: US 2026/0095072 A1
(43) Pub. Date: Apr. 2, 2026

(54) STATOR ASSEMBLY, AXIAL FLUX PERMANENT MAGNET MOTOR INCLUDING STATOR ASSEMBLY, AND MOBILITY DEVICE INCLUDING AXIAL FLUX PERMANENT MAGNET MOTOR

(71) Applicants: Hyundai Motor Company, Seoul (KR); Kia Corporation, Seoul (KR); Research & Business Foundation Sungkyunkwan University, Suwon-si (KR)

(72) Inventors: Hoo Dam LEE, Seoul (KR); Shin Gyu KIM, Hwaseong-Si (KR); Jae Wan CHOI, Ansan-Si (KR); Sung Sik KIM, Suwon-Si (KR); Se Ah PARK, Suwon-Si (KR); Tae Hyuk JI, Suwon-Si (KR); Sang Yong JUNG, Seoul (KR); Hyung Woo KIM, Suwon-Si (KR)

(73) Assignees: Hyundai Motor Company, Seoul (KR); Kia Corporation, Seoul (KR); Research & Business Foundation Sungkyunkwan University, Suwon-si (KR)

(21) Appl. No.: 18/892,048

(22) Filed: Sep. 20, 2024

(30) Foreign Application Priority Data
Feb. 19, 2024 (KR) 10-2024-0023637

(51) Int. Cl. H02K 1/14; H02K 3/52

(52) U.S. Cl. CPC H02K 1/146; H02K 3/522

(57) ABSTRACT

A stator assembly of an axial flux permanent magnet motor includes a plurality of cores repeatedly provided in a circumferential direction, and a coil mounted on the core. Opposite end portions of the core include pole shoes having an expanded external diameter. One of the pole shoes is a fixed pole shoe provided integrally with the core, and another pole shoe is a fixed pole shoe fastened to the core.

### CROSS-REFERENCE TO RELATED APPLICATION(S)

The present application claims priority to Korean Patent Application No. 10-2024-0023637 filed on Feb. 19, 2024, the entire contents of which is incorporated herein for all purposes by this reference.

### BACKGROUND OF THE PRESENT DISCLOSURE

### Field of the Present Disclosure

The present disclosure relates to a stator assembly, an axial flux permanent magnet motor including the same, and a mobility device including the same.

### Description of Related Art

In general, electric motors may be divided into DC motors and AC motors depending on a power source used, and into axial flux permanent magnet (AFPM) motors and radial flux permanent magnet (RFPM) motors depending on a direction in which magnetic flux is formed.

AFPM motors may concentrate and use magnetic flux as compared to RFPM motors, and thus may have high torque and efficiency. Accordingly, a large amount of research into AFPM motors has been conducted.

Such motors mainly include a stator around which a coil is wound to form a rotor system by applying power, the stator fixed in a housing or casing, and a rotor installed in the stator to be rotatable by a shaft, and magnetic flux generated by the stator may interact with the rotor to generate rotational torque.

Recently, research and development of various mobility devices has accelerated, and demand for electric motors has significantly increased. As electric motors used as power sources for electric vehicles, high-speed, high-output electric motors have been generally used.

Mobility devices, including hybrid electric vehicles and aerial mobility vehicles, may be partially or entirely driven by electric motors rather than internal combustion engines according to the related art. Interior permanent magnet synchronous motors (IPMSMs) having permanent magnets have been widely used as electric motors for such mobility devices. IPMSMs may have high efficiency and output. However, AFPM motors may concentrate magnetic flux as compared to RFPM motors, and thus may have high torque and efficiency. Accordingly, a large amount of research into AFPM motors has been recently conducted.

However, motors according to the related art have limitations in increasing output and in meeting the requirements of increasingly high-performance mobility devices. To concentrate magnetic flux, a core may need to have a three-dimensional shape rather than a two-dimensional shape. However, it is impossible to manufacture a core having three-dimensional shape using an automated core manufacturing method used for RFPM motors according to the related art.

In the case of AFPM motors using three-dimensional magnetic flux, a manufacturing process thereof may be significantly difficult when applying a lamination core formed by laminating electrical steel plates according to the related art. Therefore, despite low electrical conversion efficiency, a large amount of research into application of soft magnetic composite (SMC) cores has been required to ensure freedom of shape.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a motor structure configured for high torque by simply changing a core structure of an axial flux permanent magnet motor.

However, the aspects of the present disclosure are not limited to those set forth herein, and other aspects set forth herein will be more easily understood by those skilled in the art from the description below.

According to an aspect of the present disclosure, there is provided a stator assembly of an axial flux permanent magnet motor including a plurality of cores repeatedly provided in a circumferential direction, and a coil mounted on the core. Opposite end portions of the core may include pole shoes having an expanded external diameter. One of the pole shoes may be a fixed pole shoe provided integrally with the core, and another of the pole shoes may be a fixed pole shoe fastened to the core.

Furthermore, the core and the fixed pole shoe may be slidably coupled to each other.

Furthermore, one of the core and the fixed pole shoe may include a fastening groove, and another of the pole shoes may include a fastening protrusion.

Furthermore, the fastening groove and the fastening protrusion may include a length in a radial direction, and the fastening protrusion may be slidably inserted into the fastening groove in the radial direction thereof.

Furthermore, the fastening groove and the fastening protrusion may include the same shape, and a coupling tolerance between the fastening groove and the fastening protrusion may be 0.1 mm or less than 0.1 mm.

Furthermore, a bond may be coated between the fastening groove and the fastening protrusion.

Furthermore, the fastening protrusion may include a body protrusion extending in an axial direction of the motor from the core or the fixed pole shoe, and an axial intermediate portion of the body protrusion includes a fastening recess having a thickness less than a thickness of other portions of the body protrusion.

Furthermore, a surface of the fastening groove on which the core and the fixed pole shoe oppose each other may include a body groove in the core or the fixed pole shoe in an axial direction of the motor, and an axial intermediate portion of the body groove may include an inwardly protruding fastening protrusion.

Furthermore, the fastening protrusion may include a linear shape including a constant width.

Furthermore, the fastening protrusion may include a shape including a width increasing outwardly in a radial direction thereof.

Furthermore, the pole shoes may include an external diameter further expanded than an external diameter of the core in all directions.

According to another aspect of the present disclosure, there is provided an axial flux permanent magnet motor including a stator including a plurality of cores repeatedly provided in a circumferential direction of the motor and a coil mounted on the core, and a rotor including a magnetic body opposite to the stator in an axial direction of the motor, the rotor fixedly provided on a rotation shaft. Opposite end portions of the core may include pole shoes having an expanded external diameter. One of the pole shoes may be a fixed pole shoe provided integrally with the core, and another of the pole shoes may be a fixed pole shoe fastened to the core.

Furthermore, one of the core and the fixed pole shoe may include a fastening groove, and another of the pole shoes may include a fastening protrusion, and the core and the fixed pole shoe may be slidably coupled to each other.

Furthermore, a coupling tolerance between the fastening groove and the fastening protrusion may be 0.1 mm or less than 0.1 mm.

Furthermore, a bond may be coated between the fastening groove and the fastening protrusion.

According to another aspect of the present disclosure, there is provided a mobility device including a body, at least one driving means provided on the body, a battery mounted in the body, and the above-described axial flux permanent magnet motor according to an example embodiment, the axial flux permanent magnet motor connected to the battery, the axial flux permanent magnet motor providing driving force to the at least one driving means.

According to example embodiments of the present disclosure, a motor may generate higher torque by a simply changing a structure of an axial flux permanent magnet motor.

The motor may be implemented by a simple structural change, and thus may have improved performance without a significant change as compared to the related art, substantially reducing costs.

The effects of the present disclosure are not limited to those set forth herein, and other effects not set forth herein will be clearly recognized by those skilled in the art from the description below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a cross-sectional view of an axial flux permanent magnet motor according to an exemplary embodiment of the present disclosure.

FIG. 2 is a perspective view of a stator and a rotor of an axial flux permanent magnet motor according to an exemplary embodiment of the present disclosure.

FIG. 3 is a cutaway perspective view of a stator and a rotor of an axial flux permanent magnet motor according to an exemplary embodiment of the present disclosure.

FIG. 4 is a cutaway perspective view of only a core excluding a coil of a stator in FIG. 3.

FIG. 5 is an exploded perspective view of a stator core and a coil of an axial flux permanent magnet motor according to an exemplary embodiment of the present disclosure.

FIG. 6 is a perspective view of a stator core of an axial flux permanent magnet motor according to an exemplary embodiment of the present disclosure.

FIG. 7A and FIG. 7B are exploded perspective views of a stator core of an axial flux permanent magnet motor according to an exemplary embodiment of the present disclosure.

FIG. 8A and FIG. 8B are exploded perspective views of a stator core of an axial flux permanent magnet motor according to another exemplary embodiment of the present disclosure.

FIG. 9 is a table illustrating comparison between results of testing performance, such as torque and the like, of an axial flux permanent magnet motor including a stator core (c) according to an exemplary embodiment of the present disclosure, and axial flux permanent magnet motors including stator cores (a) and (b) according to other structures (comparative example embodiment).

FIG. 10, FIG. 11A and FIG. 11B are perspective views of an example of a mobility device to which a motor is applied according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Various modifications may be made to the example embodiments. Here, the example embodiments are not construed as limited to the present disclosure and should be understood to include all changes, equivalents, and replacements within the idea and the technical scope of the present disclosure.

The terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component. The term “and/or” may include combinations of a plurality of related described items or any of a plurality of related described items.

The terms such as “portion,” “part,” and the like may be used to describe various components, but the components should not be limited by the terms. The above-described terms may refer to a term indicating not only a physically/visually distinct component, but also a function or component of a corresponding portion even when not clearly divided or partitioned.

The terminology used herein is for describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in the present code, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms include the same meanings as those generally understood by one of ordinary skill in the art. Terms defined in dictionaries generally used should be construed to have meanings matching contextual meanings in the related art and are not to be construed as including an ideal or excessively formal meaning, unless otherwise defined herein.

As used herein, a mobility device may travel through a space associated with the ground, underground, air, space, sea, and/or underwater, depending on a space through the mobility device travels. A ground or underground mobility device may be provided, for example, in a form of a vehicle, a robot, or the like. An aerial or space mobility device, an urban aerial mobility device, may be provided, for example, in a form of a fixed or rotary wing aircraft according to the related art, a recently developed advanced air mobility (AAM) vehicle, an unmanned aerial vehicle or drone, a rocket, a vehicle mounted on an artificial satellite, or the like. A maritime or underwater mobility device may be, for example, a ship, submarine, or the like. The mobility device may not be limited to a particular space, but may be a mobile vehicle configured for travelling through all of the spaces described above, that is, a mobile vehicle configured for mutually travelling through a plurality of spaces, for example, an amphibious vehicle, a flying vehicle, and the like.

In the description below, the terms used in relation to direction, such as “front,” “rear,” “side,” “forward,” “rearward,” “vertical,” “lateral,” “above,” “upper,” “upper portion” “below,” “lower,” “lower portion,” and the like, are defined based on a vehicle or body of the vehicle. In addition, the terms such as first, second, A, B, (a), (b), and the like may be used herein to describe components. Each of these terminologies is not used to define an essence, order or sequence of a corresponding component but used merely to distinguish the corresponding component from other component(s).

Hereinafter, exemplary embodiments of the present disclosure will be described in more detail with reference to the appended drawings.

A motor may include a stator and a rotor, and the rotor may rotate by electromagnetic interaction between the stator and the rotor. As described above, depending on a direction in which magnetic flux is generated, the motor may be divided into an axial flux permanent magnet (AFPM) motor and a radial flux permanent magnet (RFPM) motor.

The AFPM motor may concentrate and use magnetic flux as compared to the RFPM motor, and thus may have high torque and efficiency. Accordingly, a large amount of research into AFPM motors has been conducted.

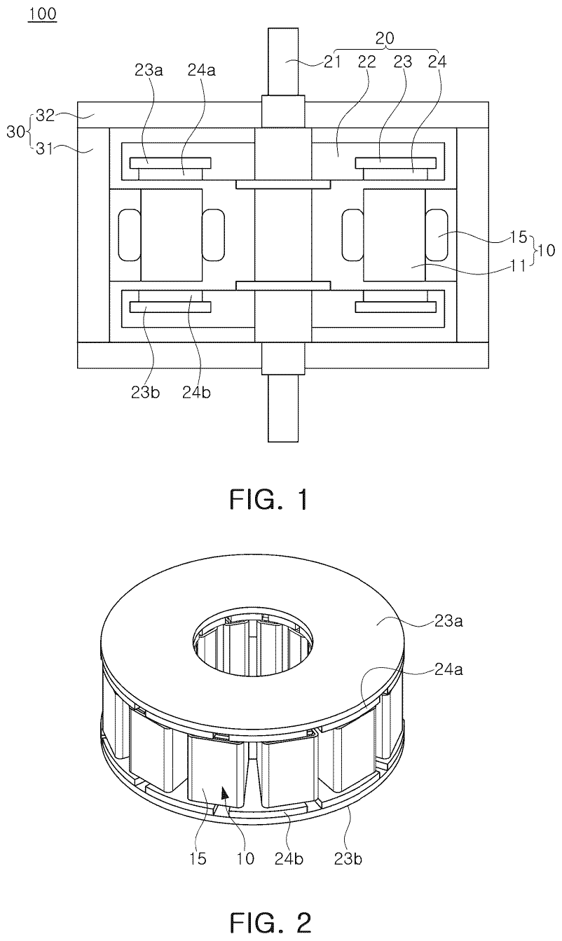

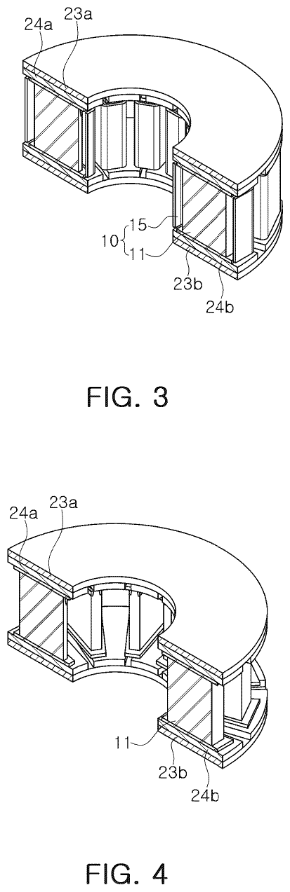

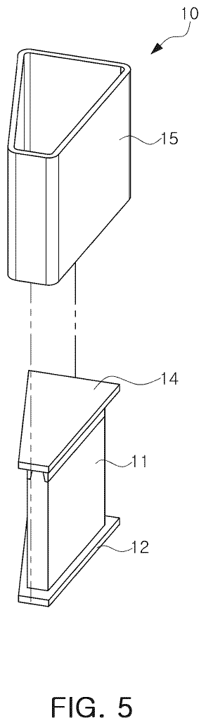

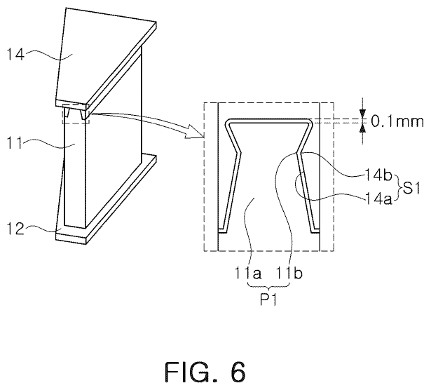

Referring to FIG. 1, FIG. 2, FIG. 3, and FIG. 4, an axial flux permanent magnet motor 100 according to an exemplary embodiment of the present disclosure may include a stator assembly 10 generating magnetic flux to form a rotating field, and a rotor assembly 20 including a magnetic body interacting within the rotating field, the rotor assembly driven to rotate. Furthermore, the axial flux permanent magnet motor 100 may include a housing 30 (31 and 32) accommodating the stator assembly 10 and the rotor assembly 20.

The axial flux permanent magnet motor 100 according to the exemplary embodiment of the present disclosure may include a stator assembly 10 including a plurality of stator cores 11 repeatedly provided in a circumferential direction and a stator coil 15 provided on the stator core 11, and a rotor assembly 20 including a magnetic body 24 opposing the stator assembly 10 in an axial direction of the motor, the rotor assembly 20 fixedly provided on a rotation shaft 21. Opposite end portions of the stator core 11 may have pole shoes 12 and 14 including an expanded external diameter. One of the pole shoes 12 and 14 may be a fixed pole shoe 12 provided integrally with the stator core 11, and the other pole shoe is a fixed pole shoe 14 fastened to the stator core 11.

The stator assembly 10 may include a plurality of stator cores 11 repeatedly provided in the circumferential direction and a stator coil 15 provided on the stator core 11. Furthermore, opposite end portions of the stator core 11 may include a pair of pole shoes 12 and 14 including an expanded external diameter, and one of the pair of pole shoes may be a fixed pole shoe 12 provided integrally with the stator core 11, and the other pole shoe may be a fixed pole shoe 14 fastened to the stator core 11.

The stator assembly 10 may include a stator core 11 and a stator coil 15. The stator core 11 may fix or support the wound stator coil 15, and may provide a path for magnetic flux generated by interaction between the stator assembly 10 and the rotor assembly 20. Furthermore, the stator core 11 may be disposed on the inside of the housing 30 to be in a form of a circular loop or ring.

The stator coil 15 may be wound around the stator core 11. The stator coil 15 may be connected to a power source to receive current, generating magnetic flux interacting with the rotor assembly 20.

The rotor assembly 20 may include a rotation shaft 21, a rotation plate 22, a rotor core 23, and a magnetic body 24.

The rotation shaft 21 may be rotatably mounted in the housing 30. The rotation shaft 21 may rotate around a rotation axis in a longitudinal direction, and front and rear sides of the rotation shaft 21 in the longitudinal direction may be rotationally supported by a bearing.

The rotation plate 22 may be fastened to the rotation shaft 21, and may transmit rotatory force, generated by the rotor core 23 and the magnetic body 24, to the rotation shaft 21. The rotation plate 22 may be in a form of a disk including a center portion to which the rotation shaft 21 is fastened.

Furthermore, the rotation plate 22 may be disposed so that a pair of rotation plates 22 (22a and 22b) oppose each other, with the stator assembly 10 interposed therebetween.

The rotor core 23 may be mounted on the rotation plate 22. The rotor core 23, corresponding to the above-described stator core 11, may fix or support the magnetic body 24 generating rotation force, and may provide a path for magnetic flux generated by interaction between the stator assembly 10 and the rotor assembly 20.

The rotor core 23 may be in a form of a disk. The rotor core 23 may correspond to the stator core 11 disposed in a form of a circular loop or ring. Furthermore, the rotor core 23 may be disposed so that a pair of rotor cores 23 (23a and 23b) oppose each other, with the stator assembly 10 interposed therebetween.

The magnetic body 24 (24a and 24b) may be mounted on the rotor core 23. The magnetic body 24 may be formed of a permanent magnet, and may generate rotation force by interacting with a rotating field formed through the stator coil 15. The rotation force may be transmitted to the rotation shaft 21 through the rotation plate 22 to rotate the rotation shaft 21.

The housing 30 may include a predetermined mounting space therein, and may accommodate the stator assembly 10 and the rotor assembly 20.

The housing 30 may include a stator housing 31 fixedly supporting the stator assembly 10 in the housing 30, and a rotor housing 32 rotatably supporting the rotation shaft 21 of the rotor assembly 20. Furthermore, the housing 30 may be formed by assembling a plurality of pieces, or may be formed as a single piece. Furthermore, the axial flux permanent magnet motor 100 may further include a sensing unit sensing rotation and a degree of rotation (speed) of the rotor assembly 20.

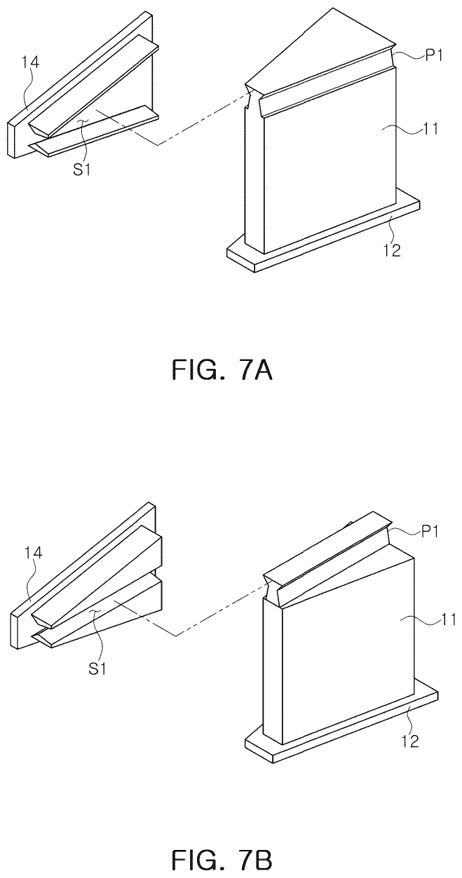

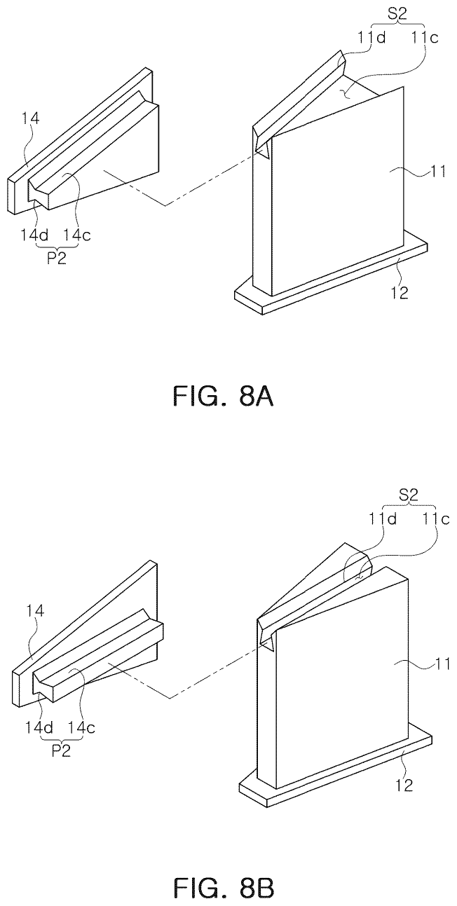

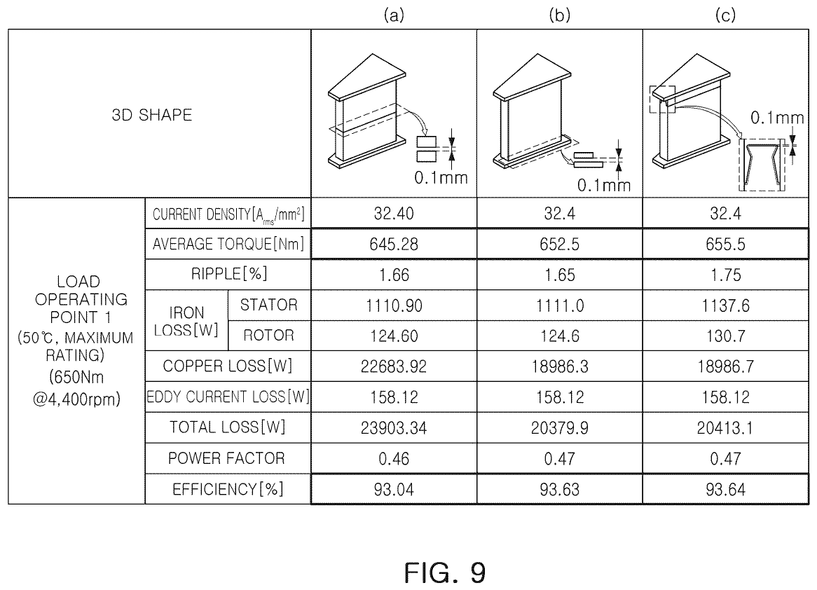

Referring to FIG. 5, FIG. 6 and FIG. 7, the stator assembly 10 provided in the axial flux permanent magnet motor 100 according to an exemplary embodiment of the present disclosure may include a plurality of stator cores 11 repeatedly provided in a circumferential direction and a stator coil 15 provided on the stator core 11. Furthermore, opposite end portions of the stator core 11 may include a pair of pole shoes 12 and 14 including an expanded external diameter, and one of the pair of pole shoes may be a fixed pole shoe 12 provided integrally with the stator core 11, and the other pole shoe may be a fixed pole shoe 14 fastened to the stator core 11.

Opposite end portions of the stator core 11 provided in the axial flux permanent magnet motor 100 according to an exemplary embodiment of the present disclosure may include a pair of pole shoes 12 and 14 including an expanded external diameter. One of the pair of pole shoes may be a fixed pole shoe 12 provided integrally with the stator core 11, and the other pole shoe may be a fixed pole shoe 14 manufactured separately and fastened to the stator core 11.

The pole shoes 12 and 14 may include an external diameter further expanded than that of the stator core 11 in all directions.

Hereinafter, for ease of description, an axial direction may be defined as a direction in which the rotation shaft 21 extends, a radial direction may be defined as a direction, perpendicular to the axial direction, and a circumferential direction may be defined as a direction in which the rotor assembly 20 rotates. Furthermore, the inside in a radial direction may refer in a direction toward a rotation axis, and the outside in a radial direction may refer in a direction outwardly from a rotation axis.

Opposite end portions of the stator core 11 may include a fixing pole shoe 12 and a fixed pole shoe 14 in an axial direction thereof. Furthermore, a plurality of stator cores 11 may be provided repeatedly in a circumferential direction, and opposite end portions of all of the plurality of stator cores 11 may include a fixing pole shoe 12 and a fixed pole shoe 14 in the axial direction thereof. However, the stator cores 11, repeatedly provided in the circumferential direction, may be disposed so that positions of the fixing pole shoe 12 and the fixed pole shoe 14 have consistency.

For example, the fixing pole shoes 12, provided on all stator cores 11, may be disposed on a lower portion in the axial direction, and the fixed pole shoes 14, provided on all stator cores 11, may be disposed on an upper portion in the axial direction thereof. Conversely, the fixing pole shoes 12 may all be disposed on the upper portion in the axial direction, and fixed pole shoes 14 may all be disposed on the lower portion in the axial direction thereof.

Furthermore, the fixing pole shoes 12 and the fixed pole shoes 14 provided on the stator core 11, repeatedly disposed in the circumferential direction, may be vertically provided in the axial direction, and may alternately oppose to each other in the circumferential direction thereof.

The stator core 11 and the fixed pole shoe 14 may be manufactured separately from each other, and may be slidably coupled to each other. To the present end, one of the stator core 11 and the fixed pole shoe 14 may include a fastening groove S1, and the other pole shoe may include a fastening protrusion P1. Furthermore, the fastening protrusion P1 may be slidably inserted into the fastening groove S1. The fastening groove S1 and the fastening protrusion P1 have a length in a radial direction, a longitudinal direction of the stator core 11, and the fastening protrusion P1 may be slidably inserted into the fastening groove S1 in the radial direction thereof.

As illustrated in FIG. 7A, the stator core 11 and the fixed pole shoe 14 may have a circumferential thickness gradually increasing outwardly in the radial direction due to the nature of the stator core 11 being repeatedly disposed in the circumferential direction to have a round shape. Accordingly, the fastening protrusion P1 may also have a circumferential thickness (width) gradually increasing in the radial direction. Accordingly, the fastening groove S1 may also have a circumferential width gradually increasing in the radial direction. In such a structure, the fixed pole shoe 14 may be slidably inserted into the stator core 11 while moving from the inside to the outside in the radial direction.

As illustrated in FIG. 7B, even when the stator core 11 and the fixed pole shoe 14 have a shape including a circumferential thickness (width) gradually increasing in the radial direction, the fastening protrusion P1 and the fastening groove S1 may have a linear shape including a constant width in the radial direction. In the instant case, fastening directionality may not need to be considered, further improving assembly efficiency.

The fastening groove S1 and the fastening protrusion P1 have the same shape, and a coupling tolerance between the fastening groove S1 and the fastening protrusion P1 may be 0.1 mm or less than 0.1 mm. Accordingly, the fastening protrusion P1 may be coupled to the fastening groove S1 in a fitting manner, and fixed to the fastening groove S1 without substantially any additional media.

However, to improve bonding strength, a bond may be coated between the fastening groove S1 and the fastening protrusion P1 to perform additional fixation (coupling).

The fastening protrusion P1 may include a body protrusion 11a extending in the axial direction from the stator core 11, and an axial intermediate portion of the body protrusion 111a may include a fastening recess 11b including a thickness less than those of other portions. Furthermore, a surface of the fastening groove S1 on which the stator core 11 and the fixed pole shoe 14 oppose each other may include a body groove 14a in the fixed pole shoe 14 in the axial direction, and an axial intermediate portion of the body groove 14a may include an inwardly protruding fastening protrusion 14b.

Accordingly, when the body protrusion 11a is slidably inserted along the body groove 14a, the fastening protrusion 14b may be fitted into the fastening recess 11b so that the fastening protrusion 14b and the fastening recess 11b may be securely coupled (fastened) to each other.

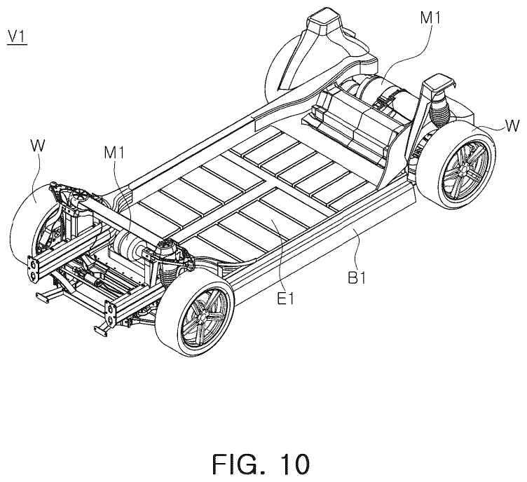

Furthermore, as illustrated in FIGS. 8A and 8B, contrary to the above-described embodiment, the stator core 11 may include a fastening groove S2, and the fixed pole shoe 14 may include a fastening protrusion P2. In the instant case, the fixed pole shoe 14 may include a body protrusion 14c extending in the axial direction, and an axial intermediate portion of the body protrusion 14c may include a fastening groove 14d including a thickness less than those of other portions. Furthermore, the stator core 11 may include a body groove 11c, and an axial intermediate portion of the body groove 11c may include an inwardly protruding fastening protrusion 11d.

As illustrated in FIGS. 8A and 8B, even in a case in which the stator core 11 includes the fastening groove S2 and the fixed pole shoe 14 includes the fastening protrusion P2, the fastening protrusion P2 and the fastening groove S2 may have a widening shape or a linear shape.

As illustrated in FIG. 8A, the stator core 11 and the fixed pole shoe 14 may have a circumferential thickness gradually increasing outwardly in the radial direction. Accordingly, the fastening protrusion P2 may also have a circumferential thickness (width) gradually increasing in the radial direction. Accordingly, the fastening groove S2 may also have a circumferential width gradually increasing in the radial direction. In such a structure, the fixed pole shoe 14 may be slidably inserted into the stator core 11 while moving inwardly in the radial direction.

As illustrated in FIG. 8B, even when the stator core 11 and the fixed pole shoe 14 have a shape including a circumferential thickness (width) gradually increasing outwardly in the radial direction, the fastening protrusion P2 and the fastening groove S2 may have a linear shape including a constant width in the radial direction. In the instant case, fastening directionality may not need to be considered, further improving assembly efficiency.

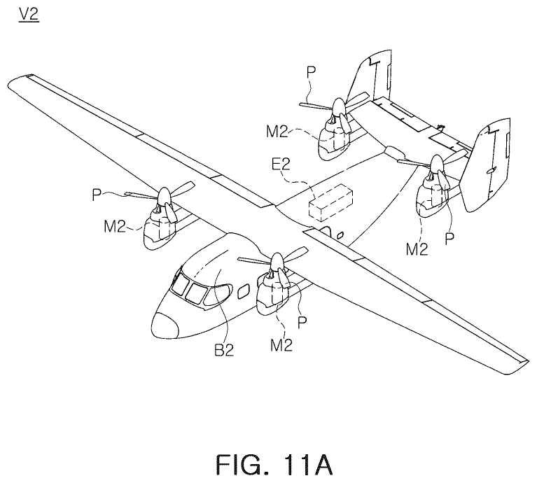

FIG. 9 is a table illustrating a comparison between results of testing performance, such as torque and the like, of an axial flux permanent magnet motor including a stator core (c) according to an exemplary embodiment of the present disclosure, and axial flux permanent magnet motors including stator cores (a) and (b) according to other structures (comparative example embodiment).

As illustrated in FIG. 9, the axial flux permanent magnet motor (c) including the stator core 11 according to the exemplary embodiment of the present disclosure may average torque and efficiency higher than those of the motors including the cores (a) and (b) including other structures.

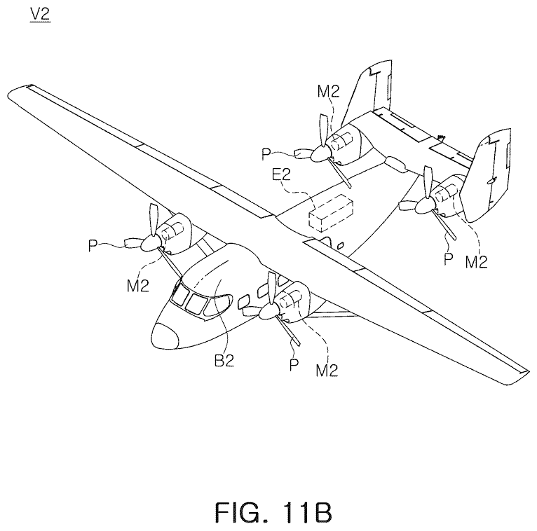

FIGS. 10, 11A, and 11B are perspective views of an example of a mobility device to which the axial flux permanent magnet motor 100 according to an exemplary embodiment of the present disclosure is applied.

Mobility devices V1 and V2 according to an exemplary embodiment of the present disclosure may include at least bodies B1 and B2, driving means W and P provided on the bodies B1 and B2, motors M1 and M2 linked to the driving means W and P, and batteries E1 and E2 providing power to the motors. The motors M1 and M2, provided in the mobility devices V1 and V2 according to the present example embodiment, may be the motor 100 described with reference to in FIGS. 1 to FIG. 9. The motor 100 may be provided as described with reference to FIG. 1, FIG. 2, FIG. 3, FIG. 4, FIG. 5, FIG. 6, FIG. 7, FIG. 8 and FIG. 9, and thus a detailed description of such a structure will be omitted.

Referring to FIG. 10, the mobility device V1 according to an exemplary embodiment of the present disclosure may be a vehicle configured for travelling on the ground. The vehicle V1, a mobility device, may include at least a body B1, a wheel W provided on the body B1 as a driving means, a motor M1 linked to the wheel W, and a battery E1 providing power to the motor.

Furthermore, referring to FIG. 11A and FIG. 11B, the mobility device V2 according to an exemplary embodiment of the present disclosure may be an aerial mobility vehicle travelling in the air. The aerial mobility V2 according to an exemplary embodiment of the present disclosure may include at least a fuselage B2 as a body, a propellant (for example, a propeller P) provided in the fuselage B2 as a driving means, a motor M2 linked to the propellant P, and a battery E2 providing power to the motor.

FIG. 11A illustrates a position of the propeller P when the air mobility vehicle V2 takes off or lands, or hovers for pivoting or the like at a particular point, and FIG. 11B illustrates a position of the propeller P when the air mobility vehicle V2 shifts a position thereof, that is, travels. That is, a direction in which the propeller P, a propellant of the air mobility vehicle V2, is oriented may be tilted, and the motor 100 driving the propeller P may also be tilted accordingly.

In the hovering mode illustrated in FIG. 11A, a main wing and/or tail wing tilting propellant P may pivot to be substantially perpendicular to the fuselage B2. In the cruising mode illustrated in FIG. 11B, a main wing and/or tail wing non-tilting propellant P may pivot to be substantially parallel to the fuselage B2. Tilting of the main wing and/or tail wing tilting propellant P may be synchronized depending on a flight mode, and tilting of each propellant may be adjusted differently depending on posture control and flight conditions in the same flight mode.

Although not illustrated, a mobility device may travel through a space associated with the ground, underground, air, space, sea, and/or underwater, depending on a space through the mobility device travels. A ground or underground mobility device may be provided, for example, in a form of a vehicle, a robot, or the like. An air or space mobility device, an aerial mobility vehicle, may be provided, for example, in a form of a fixed or rotary wing aircraft according to the related art, a recently developed advanced air mobility (AAM) vehicle, an unmanned aerial vehicle or drone, a rocket, a vehicle mounted on an artificial satellite, or the like. A maritime or underwater mobility device may be, for example, a ship, submarine, or the like. The mobility device may not be limited to a particular space, but may be a mobile vehicle configured for travelling through all of the spaces described above, that is, a mobile vehicle configured for mutually travelling through a plurality of spaces, for example, an amphibious vehicle, a flying vehicle, and the like.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A stator assembly of an axial flux permanent magnet motor, the stator assembly comprising:
a plurality of cores repeatedly provided in a circumferential direction of the motor; and
a coil mounted on the core,
wherein opposite end portions of the core in an axial direction of the motor include pole shoes having an external diameter expanding in a radial direction of the motor, and
wherein one of the pole shoes is a fixed pole shoe provided integrally with the core, and another pole shoe of the pole shoes is a fixed pole shoe fastened to the core.

2. The stator assembly of claim 1, wherein the core and the fixed pole shoe are slidably coupled to each other.

3. The stator assembly of claim 2, wherein one of the core and the fixed pole shoe includes a fastening groove, and another of the core and the fixed pole shoe includes a fastening protrusion.

4. The stator assembly of claim 3, wherein the fastening groove and the fastening protrusion are formed in the radial direction, and the fastening protrusion is slidably inserted into the fastening groove in the radial direction.

5. The stator assembly of claim 3, wherein the fastening groove and the fastening protrusion have a same shape, and a coupling tolerance between the fastening groove and the fastening protrusion is 0.1 mm or less than 0.1 mm.

6. The stator assembly of claim 3, wherein a bond is coated between the fastening groove and the fastening protrusion.

7. The stator assembly of claim 3,
wherein the fastening protrusion includes a body protrusion extending in the axial direction from the core or the fixed pole shoe, and
wherein an axial intermediate portion of the body protrusion includes a fastening recess having a thickness less than a thickness of other portions of the body protrusion in the axial direction.

8. The stator assembly of claim 3,
wherein a surface of the fastening groove on which the core and the fixed pole shoe oppose each other includes a body groove in the core or the fixed pole shoe in the axial direction, and
wherein an axial intermediate portion of the body groove includes an inwardly protruding fastening protrusion.

9. The stator assembly of claim 3, wherein the fastening protrusion linearly extends in the radial direction with a constant width.

10. The stator assembly of claim 9, wherein the fastening groove linearly extends in the radial direction with a constant width to correspond to the fastening protrusion.

11. The stator assembly of claim 3, wherein a width of the fastening protrusion increases in the radial direction.

12. The stator assembly of claim 11, wherein a width of the fastening groove increases in the radial direction to correspond to the fastening protrusion.

13. The stator assembly of claim 1, wherein the pole shoes include an external diameter further expanded than an external diameter of the core in all directions.

14. An axial flux permanent magnet motor comprising:
a stator including a plurality of cores repeatedly provided in a circumferential direction of the motor and a coil mounted on the core; and
a rotor including a magnetic body opposite to the stator in an axial direction of the motor, the rotor fixedly provided on a rotation shaft of the motor,
wherein opposite end portions of the core include pole shoes having an external diameter expanding in a radial direction of the motor, and
wherein one of the pole shoes is a fixed pole shoe provided integrally with the core, and another pole shoe of the pole shoes is a fixed pole shoe fastened to the core.

15. The axial flux permanent magnet motor of claim 14,
wherein one of the core and the fixed pole shoe includes a fastening groove, and another of the core and the fixed pole shoe includes a fastening protrusion, and
wherein the core and the fixed pole shoe are slidably coupled to each other.

16. The axial flux permanent magnet motor of claim 15, wherein a coupling tolerance between the fastening groove and the fastening protrusion is 0.1 mm or less than 0.1 mm.

17. The axial flux permanent magnet motor of claim 15, wherein a bond is coated between the fastening groove and the fastening protrusion.

18. The axial flux permanent magnet motor of claim 15,
wherein the fastening protrusion linearly extends in the radial direction with a constant width, and
wherein the fastening groove linearly extends in the radial direction with a constant width to correspond to the fastening protrusion.

19. The axial flux permanent magnet motor of claim 15,
wherein a width of the fastening protrusion increases in the radial direction, and
wherein a width of the fastening groove increases in the radial direction to correspond to the fastening protrusion.

20. A mobility device comprising:
a body;
at least one driving means provided on the body;
a battery mounted in the body; and
the axial flux permanent magnet motor of claim 12, the axial flux permanent magnet motor connected to the battery, the axial flux permanent magnet motor providing driving force to the at least one driving means.
